(19) United States
(12) Patent Application Publication
(10) Pub. No.: US 2004/0205488 A1
(43) Pub. Date: Oct. 14, 2004

(54) Active web page for editing with any browser

(76) Inventor: Randolph Allan Fry, Danville, CA (US)

Correspondence Address: RANDOLPH FRY, 967 RICHARD LANE, DANVILLE, CA, 94526, US

(21) Appl. No.: 09/683,143

(22) Filed: Nov. 27, 2001

(51) Int. Cl. G06F 17/24

(52) U.S. Cl. 715/501.1; 715/513

(57) ABSTRACT

A method for creating and editing Web pages using a browser on a personal computer with no additional resident program. Selected HTML element tags and content controlled by the tags are stored separately in a data stores. A Web server returns a requested HTML page from the data stores and renders the selected HTML element tags and content usually consisting of text, hypertext links, graphics, sounds, and hypermedia links. Each tag's content is individually wrapped in “hyperedit”links making the entire visible document active. Each hyperedit link invokes an edit window with input boxes containing the selected HTML tag, its attributes, and content respectively. The user changes any or all the entries and invokes a button to update the data stores values.

### CROSS REFERENCE TO RELATED APPLICATIONS

U.S. Pat. Nos. 6,295,542 6,289,513 6,278,448

### BACKGROUND OF INVENTION

In a distributed computing environment known as the World Wide Web, Internet or simply the Web, certain computers, known as servers, are used primarily to store and supply information. Other computers on the Web, known as clients, allow a user to download replicas of the information in the form of Web pages from the servers using Web browsers.

Many programs exist for producing and editing Web pages authored in Hypertext Mark-up Language (HTML) format. Many of these programs have Graphic User Interfaces (GUI) obviating the need for knowledge of HTML element tags. All of these applications require a program resident on the computer producing or editing the HTML Web pages.

Some of these applications use the power of a server-side script to combine server-side code with HTML code to produce dynamically generated HTML element tags and content for client-side Web browsers. Some of the more popular applications are ColdFusion®, DreamWeaver®, PHP®, InterDev® or FrontPage®.

Small business website owners usually don't want to and don't have the time to learn these Web page production technologies and they don't want to purchase these applications and install them on their personal computers. These business owners and marketing professionals still want to be able to change the content of their web site. Some want to change the content every day and they don't want a web developer involved. This involvement only slows down the cycle time and the content usually does not met the expectations of the website owner, if only because the web developer does not know the website owner's business and peculiar terminology and business culture.

Thus, there is a need to provide a way for website owners to edit their Web page content using only a browser and publish their changes to their Web server for viewing by users of the Web.

### SUMMARY OF INVENTION

Briefly, this invention is a system of hyperedit links which are wrapped around visible document content and reference the associated HTML element tag.

More specifically, a HTML document paragraph may contain the following:

1. a paragraph element tag “<P>”,

2. text “My favorite”,

3. a bold element tag pair “<B> search </B>,

4. an anchor element tag “<A HREF=http://www.Usearch.com>engine</A>”, and

5. an image element tag “<IMG SRC=www.Usearch.com/images/new.gif>”.

All these tags control the visible display of the HTML document. The “<P>” element tag creates a paragraph marker in a HTML document and the text that follows is positioned against the left margin and 2 lines down from the previous text. The “<B></B>”element tag pair bolds the text enclosed in the tags. The anchor element tag pair “<A HREF></A>”creates a hypertext link. The image element tag “<IMG SRC>”displays the specified image source file.

The invention separates these HTML element display control tags and the content they are intended to control. Each HTML tag and its associated content is stored separately with a single record reference. Many records may be required to render an entire Web page document.

In the edit mode, the invention renders the HTML display control tags as it would in normal viewing mode, but wraps the associated content in hyperedit links to create a completely active HTML document ready for editing.

### BRIEF DESCRIPTION OF DRAWINGS

The foregoing aspects and many of the attendant advantages of this invention will become more readily appreciated by reference to the following drawings and detailed descriptions:

FIG. 1 is a block diagram of the hyperedit link wrapping process.

### DETAILED DESCRIPTION

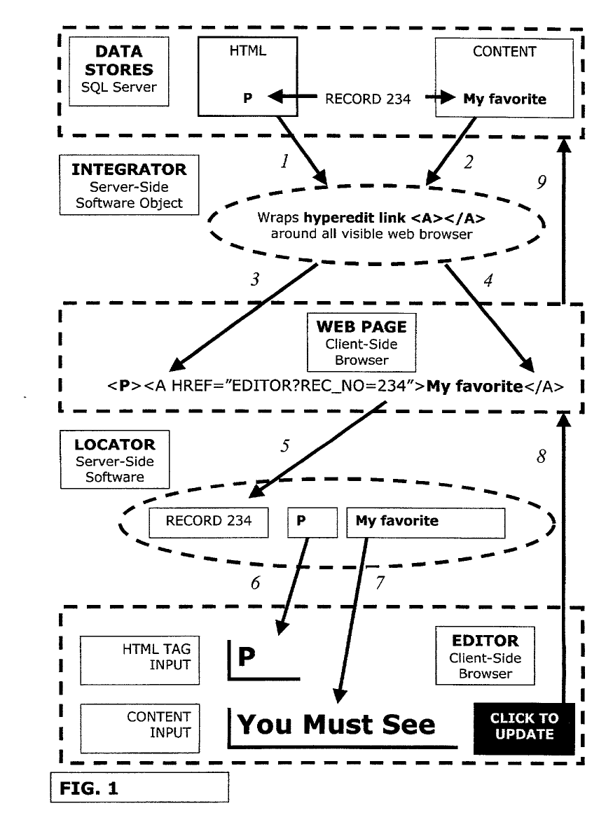

FIG. 1 shows blocks labeled “DATA STORES”, “INTEGRATOR”, “WEB PAGE”, “LOCATOR”, and “EDITOR” making up a typical embodiment of the invention where the DATA STORES, INTEGRATOR, and LOCATOR are server-side storage and server scripts. The WEB PAGE and EDITOR represent client-side browser windows. In the DATA STORES, HTML element tags and CONTENT are stored separately. Each record contains a HTML tag and CONTENT pair. Many records may be required to make an entire Web page.

When a server-side Web page is requested by a client-side Web browser using the invention in the edit mode, the INTEGRATOR recursively retrieves HTML (1) and CONTENT (2) in ordered records from the DATA STORES. The INTEGRATOR wraps the CONTENT in hyperedit links. The output is sent to the requesting Web browser, with the hyperedit link tags (3) and (4), to be rendered in a WEB PAGE.

The entire visible document content is thus rendered active. The user has only to move the mouse pointer over the text, graphic, or hypertext link and click to invoke the LOCATOR and EDITOR. The LOCATOR uses the record number (5) to locate the HTML tag (6) and CONTENT (7) in the DATA STORES and display both in separate input text boxes in the EDITOR ready for editing.

The user edits the HTML tag and/or CONTENT and clicks the UPDATE button to post the Web browser form element change(s) (8) to the WEB PAGE. The WEB PAGE, using the record number, updates (9) the DATA STORES using a server-side script (not shown).

The embodiments of the invention in which an exclusive property or privilege is claimed are defined as follows:

1. A computer-based method of creating hypertext links using a markup language for editing Web page content, the method comprising:
providing each hypertext markup language element stored in association with the content upon which it operates;
inserting the content into a hypertext link (“hyperedit”link) wherein the reference includes an associated address specification that identifies a location at which the stored markup language element and content is available for retrieval and update; and
displaying at least one markup language element with associated content in a hyperedit link.

2. The method of claim 1, further comprising:
in response to invoking a hyperedit link, the associated markup language element and content is retrieved using the address specification.

3. The method of claim 2, wherein the associated tag and content are displayed a Web browser form element for editing.

4. The method of claim 3, wherein a Web browser form element is invoked submitting updates to a stored markup language element and content using the associated address specification.

5. The method of claim 1, wherein the markup language instructions are hypertext markup language instructions.
